(19) United States
(12) Patent Application Publication
(10) Pub. No.: US 2014/0283533 A1
(43) Pub. Date: Sep. 25, 2014

(54) Apparatus and Method for Electrical Transport Refrigeration in a Tractor-Trailer System

(71) Applicant: Aura Systems, Inc., EI Segundo, CA (US)

(72) Inventors: Zvi Kurtzman, Sandy Springs, CA (US); Si Ryong Yu, Gyeonggi-do (KR); Gary Tatum, McDonough, GA (US)

(21) Appl. No.: 13/849,464

(22) Filed: Mar. 22, 2013

(51) Int. Cl. B60R 16/03; B60H 1/00

(52) U.S. Cl. CPC B60R 16/03; B60H 1/00642
USPC 62/56; 62/243; 307/130; 307/9.1

(57) ABSTRACT

An apparatus and method for electrical transport refrigeration, including generating a direct current (DC) voltage; storing the DC voltage in a high voltage DC storage; sensing a current requirement from an electrical load (e.g., a refrigeration unit), wherein the current requirement is proportional to a power requirement of the electrical load; transporting the DC voltage from the high voltage DC storage to an inverter, wherein the DC voltage is in an amount consistent with the power requirement; converting the DC voltage to an inverted AC voltage: determining a voltage in a voltage path; and triggering a switch to connect the electrical load to the voltage path it the voltage is the inverted AC voltage. And, the apparatus and method may include connecting a battery to an operating control unit of the refrigeration unit to enable a soft start of a compressor. In one example, the apparatus is a tractor-trailer system.

### FIELD

This disclosure relates generally to apparatus and methods for transport refrigeration. More particularly, the disclosure relates to electrical transport refrigeration in a tractor-trailer system.

### BACKGROUND

Providing adequate electric power to supply an electric refrigeration unit is particularly important when the refrigeration unit is part of a moving vehicle. Unlike other electrical loads, a refrigeration unit cannot be turned off if the refrigeration unit houses perishable goods. Thus, as part of a moving vehicle, the refrigeration unit must be supplied with electric power whether the vehicle is moving or not. This provides a unique challenge in that while the vehicle is moving, the refrigeration unit may need to get its electric power input from one source, but may need to find an alternate source when the vehicle is not moving. And, the transition of power sources must be continuous and seamless to keep the refrigeration unit's perishable content from spoiling.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Disclosed is an apparatus and method for electrical transport refrigeration in a tractor-trailer system. According to one aspect, a method for electrical transport refrigeration, including generating a direct current (DC) voltage; storing the DC voltage in a high voltage DC storage; sensing a current requirement from an electrical load, wherein the current requirement is proportional to a power requirement of the electrical load; transporting the DC voltage from the high voltage DC storage to an inverter, wherein the DC voltage is in an amount consistent with the power requirement; converting the DC voltage to an inverted AC voltage; determining a voltage in a voltage path; and triggering a switch to connect the electrical load to the voltage path if the voltage is the inverted AC voltage, in one example, the method further includes connecting a battery to an operating control unit of the refrigeration unit to enable a soil start of the compressor.

According to another aspect, a method for electrical transport refrigeration, including generating a direct current (DC) voltage or an unregulated alternating current (AC) voltage; rectifying the unregulated AC voltage to provide a rectified DC voltage, or treating the DC voltage as the rectified DC voltage; storing the rectified DC voltage in a high voltage DC storage; sensing a current requirement from an electrical load, wherein the current requirement is proportional to a power requirement of the electrical load; transporting, the DC voltage from the high voltage DC storage to an inverter, wherein the DC voltage is in an amount consistent with the power requirement; converting the rectified DC voltage to an inverted AC voltage; determining a voltage in a voltage path; and triggering a switch to connect the electrical load to the voltage path if the voltage is the inverted AC voltage. In one example, the method further includes connecting a battery to an operating control unit of the refrigeration unit to enable a soft start of the compressor.

According to another aspect, a tractor-trailer system for electrical transport refrigeration, including a generator for generating a direct current (DC) voltage; a high voltage DC storage for storing the DC voltage; a current sensor for sensing a current requirement from an electrical load, wherein the current requirement is proportional to a power requirement of the electrical load; an electrical cable for transporting the DC voltage from the high voltage DC storage to an inverter, wherein the DC voltage is in an amount consistent with the power requirement, and wherein the inverter converts the DC voltage to an inverted AC voltage; a voltage sensor for determining a voltage in a voltage path; and a switch for connecting the electrical load to the voltage path if the voltage is the inverted AC voltage. In one example, the tractor-trailer stem includes a battery for supplying a battery voltage to an operating control unit of the refrigeration unit to enable a soft star of the compressor.

According to another aspect, a tractor-trailer system for electrical transport refrigeration, including a generator source for generating a direct current (DC) voltage or an unregulated alternating current (AC) voltage; a rectifier for rectifying the unregulated AC voltage to provide a rectified DC voltage, or an electrical wire for treating the DC voltage as the rectified DC voltage; a high voltage DC storage for storing the rectified DC voltage; a current sensor for sensing a current requirement from an electrical load, wherein the current requirement is proportional to a power requirement of the electrical load: an electrical cable for transporting the DC voltage from the high voltage DC storage to an inverter, wherein the DC voltage is in an amount consistent with the power requirement, and wherein the inverter converts the DC voltage to an inverted AC voltage; a voltage sensor for determining a voltage in a voltage path; and a switch for connecting the electrical load to the voltage path if the voltage is the inverted AC voltage. In one example, the tractor-trailer system includes a battery for supplying a battery voltage to an operating control unit of the refrigeration unit to enable a soft start of the compressor.

Advantages of the present disclosure may include fuel cost savings by reducing the use of diesel engines to power an electrical load such as a refrigeration unit, reduction in harmful emissions by limiting the use of diesel engines that emit environmentally harmful emission, and by providing flexibility for alternate electrical sources to power an electrical load, such as a refrigeration unit.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of a tractor and trailer system with refrigeration unit housed within the trailer.

FIG. 2 illustrates an example of tractor-trailer interface.

FIG. 3 illustrates an example of voltages paths configured by the shore power switch.

FIG. 4 illustrates an example of a battery-operation control unit interface.

FIG. 5 illustrates an example of a shore power-operation control unit interface.

FIG. 6 illustrates an example flow diagram for transport refrigeration.

FIG. 7 illustrates an example of a device including a processor in communication with a memory for executing transport refrigeration.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In many tractor-trailer systems, a refrigeration unit is part of the trailer. The refrigeration unit houses perishable goods that are transported by the tractor-trailer system over long distances and often over many days or even weeks. In one example, the refrigeration unit in the tractor-trailer system is powered by the tractor's engine while the tractor-trailer is in motion. In one example, the tractor uses a diesel engine. When the tractor-trailer is not in motion (such as in the “park” configuration) with the tractor engine off, the refrigeration unit is powered by plugging into shore power, if available.

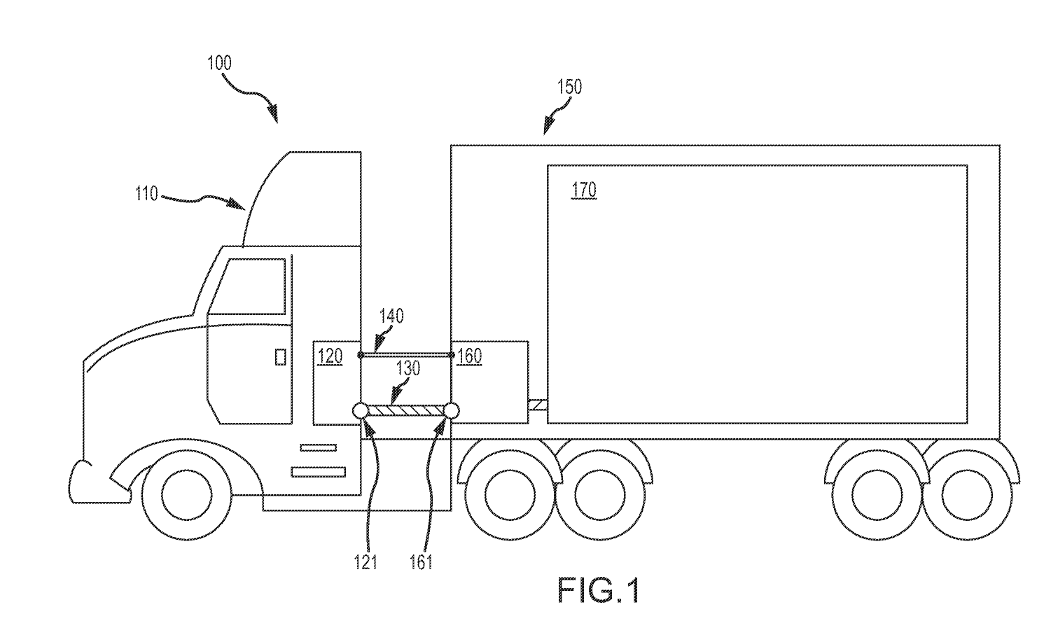

FIG. 1 illustrates an example of a tractor and trailer system 100 with an electrical cable 130 connecting the tractor 110 and the trailer 150. As shown in the example, in FIG. 1, the electrical cable connects an electrical control unit (ECU) 120 with an inverter unit 160. In one example, the electrical control unit (ECU) is also known as an electronic control unit. In this example, the ECU 120 is located in the tractor 110 and the inverter unit 160 is located in the trailer 150. A first point of connection 121 of the electrical cable 130 is the interface with the ECU 120. A second point of connection 161 of the electrical cable 130 is the interface with the inverter unit 160. In one example, the electrical cable 130 is an 800-1200 Volt (within some tolerance, e.g., 5%) direct current (DC) power bus.

In one example, the trailer 150 includes a refrigeration unit 170 which is an electrical load. Although a refrigeration unit is illustrated, one skilled in the art would understand that other types of electrical loads may take the place of the refrigeration unit and still be within the scope and spirit of the present disclosure.

The refrigeration unit 170 requires alternating current (AC) voltage to operate. In one aspect, the AC voltage is supplied to the refrigeration unit 170 by the inverter unit 160. Although the output of the inverter unit 160 is AC voltage, the input electrical source to the inverter unit 160 is a direct current (DC) voltage supplied through the ECU 120. In one example, one or more generators are connected to the ECU 120 to supply the DC voltage. In one example, one or more generators are connected to the ECU 120 to output AC voltage which is then rectified (e.g., by a rectifier) to output DC voltage. In one example, a rectifier is part of either the generator or the ECU. In another example, a rectifier is external to the generator and the ECU. The one or more generators may obtain their voltage source from the engine diesel engine) of the tractor while the tractor is on (i.e., in motion).

Thus, in one example, the one or more generators supplies the ECU 120 to enable it to output DC voltages In one example, the ECU 120 supplies 750-1200 Volts DC to the inverter unit 160 through the electrical cable 130. The electrical cable 130, in this example, is rated as an 800-1200 Volt (within some tolerance, e.g., 5%) DC power bus. In one example, the output of the inverter unit 160 to the refrigeration unit 170 is between 210 to 480 Volts AC. In one example, the output of the inverter unit 160 is a three phase AC waveform.

In one aspect, a communication line 140 is coupled between the tractor 110 and the trailer 150. The communication line 140 allows information exchange between the tractor 110 and the trailer 150. In one example, the communication line 140 provides communication of the interlock features of the electrical cable 130 between the tractor 110 and the trailer 150. For example, through the communication line 140, a digital signal processor (DSP) associated with the trailer can communicate with a digital signal processor (DSP) associated with the tractor. In one example, the tractor 110 and the trailer 150 are also coupled by a CAN (controller area network) bus J1939 cable for communication and diagnostics among vehicle components. In one aspect, the communication line 140 is a CAN bus J1939 cable and the interlock features of the electrical cable 130 is communicated between the tractor 110 and the trailer 150 through the CAN bus J1939 cable. In another aspect, the communication line 140 is separate cable from a CAN bus J1939 cable which also couples the tractor 110 and the trailer 150.

In one example, the tractor 110 includes a first digital signal processor (DSP) system 115 (not shown in FIG. 1), and the trailer 150 includes a second digital signal processor (DSP) system 155 (not shown in FIG. 1). In one example, the communication line 140 connects the first DSP system 115 with the second DSP system 155 to allow the two DSPs to communicate with one another. In one example, the first DSP system 115 is coupled to the ECU 120 or the first DSP system 115 may be a component within the ECU 120. In one example, the second DSP system 155 is coupled to the inverter 160 or the second DSP system 155 may be a component within the inverter 160. In the latter case, the inverter 160 is an inverter system that includes a processing function and an inverting function. In one example, the communication line 141) is part of the electrical cable 130.

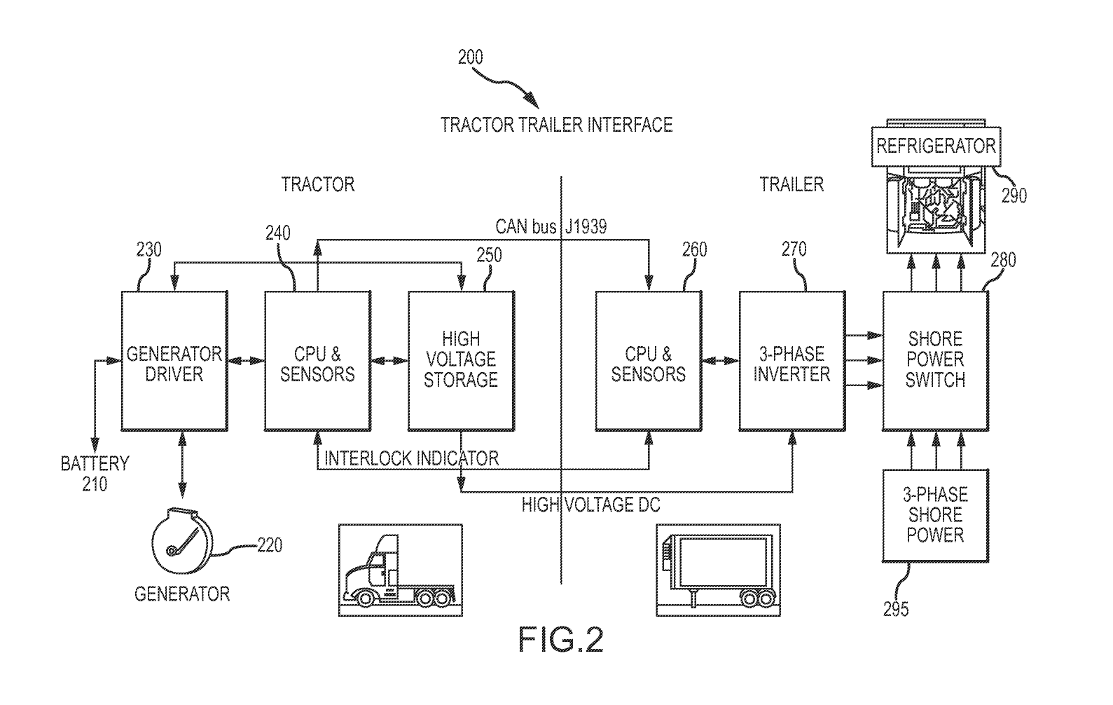

FIG. 2 illustrates an example of tractor-trailer interface 200. In one aspect, the tractor side includes a battery 210, a generator 220, a generator driver 230, a first CPU & sensor system 240 and a high voltage storage 250. In one aspect, the trailer side includes a second CPU & sensor system 260, an inverter 270, a shore power switch 280, a refrigeration unit 290 (e.g., an electric refrigeration unit). In one example, the inverter 270 is a 3 phase inverter (shown in FIG. 2). In one example, the refrigeration unit 290 is replaced with an electrical load. The shore power 295 is part of a shore power grid. In one example, the shore power 295 is a 3 phase shore power (shown in FIG. 2).

The battery 210 may be used to supply one or more electronic circuitry of the tractor-trailer system. In one example, the battery 210 supplies voltage to an operation control unit (OCU) 291 (of the refrigeration unit 290) to keep the OCU 291 in a ready operational state. In one example, the battery 210 supplies voltages to the first CPU and sensor system 240. In one example, the battery 210 supplies voltages to the second CPU and sensor system 260. In one example, the battery 210 is used to provide the initial current to the generator driver 230 to initiate excitation of the coils in the generator 220.

In one example, the generator 220 is part of a voltage source that works in conjunction with the generator driver 230. In one example, the generator driver 230 controls and for monitors the voltage distribution from the generator 220. In one example, generator driver 230 provides a voltage regulation function. In one example, generator driver 230 provides a current limiting function.

In one example, the output from the generator 220 is a 3-phase unregulated alternating current (AC) voltage. The AC voltage is then rectified by a rectifier to produce direct current (DC) voltage to be transferred on a DC bus to an electrical load (e.g., refrigeration unit 290). In one example, the DC bus is part of the electrical cable 130 (shown in FIG. 1). In one example, the rectifier is part of the generator driver 230. In one example the rectifier uses one of the following technologies: metal-oxide-semiconductor field-effect transistor (MOSFET) technology or insulated-gate bipolar transistor (IGBT) technology. One skilled in the art would understand that other types of technologies for the rectifier are within the scope and spirit of the present disclosure.

Although only one generator 220 is shown, multiple generators 220 may be used to supply the voltage. In one example, the generator 220 is a multiple stage axial induction generator with multiple rotors and multiple stators. That is, the multiple stage axial induction generator includes multiple stacking of rotors and stators. The function of the generator 220 is to supply the voltage to the electrical load (e.g., refrigeration unit 290).

In one example, the first CPU & sensor system 240 is part of the electrical control unit (ECU) 120. For example, the ECU may include a central processing unit (CPU) and one or more sensors for monitor various status conditions. Examples of the one or more sensors may include, but are not limited to, thermal sensors, current sensors, voltage sensors and/or revolution per minute (RPM) sensors, etc. In one example, a RPM sensor may be used to determine the position and/or rotational speed (RPM) of a crank. For example, the ECU may use the information transmitted by the one or more sensors to control parameters such as ignition timing and fuel injection timing of the tractor engine. And, for example, the sensor output may also be associated with other sensor data to derive the combustion cycle of the tractor engine. Additionally, the one or more sensors may be used to derive information relating to the voltage source(s), the electrical load requirement and/or the interlock interface of the electrical cable 130 connecting the tractor 110 and the trailer 150. In one example, the one or more sensors may include one or more of the following: a proximity sensor, a magnetic sensor, an electromagnetic sensor, an optoelectronic sensor, an infrared sensor, a radio frequency (RF) sensor, or a piezoelectric sensor. In one example, the one or more sensors may monitor the interlocking condition of the electrical cable 130 with its interface with the tractor. The one or more sensors may include more than one type of sensors working in conjunction.

In one example, the tractor 110 includes a high voltage storage 250 for storing voltages for outputting to the electrical load (e.g., refrigeration unit 290) of the trailer 150. In one example, the high voltage storage includes one or more high voltage capacitors.

On the trailer side, in one example, the second CPU and sensor system 260 may be part of the second DSP system 155. The second CPU and sensor system 260 may include one or more central processing units (CPU) and/or one or more sensors. Examples of the one or more sensors may include, but are not limited to, thermal sensors, current sensors and voltage sensors. And, in one example, the one or more sensors may include one or more of the following: a proximity sensor, a magnetic sensor, an electromagnetic sensor, an optoelectronic sensor, an infrared sensor, a radio frequency (RF) sensor, or a piezoelectric sensor. In one example, the one or more sensors may monitor the interlocking condition of the electrical cable 130 with its interface with the trailer. The one or more sensors may include more than one type of sensors working in conjunction. In one example, the CPU and one or more sensors work in conjunction to monitor various status conditions and/or to communicate the status to the first CPU and sensor unit 240 on the tractor side.

In one example, the inverter 270 is part of the inverter unit 160 shown in FIG. 1. Although FIG. 2 shows a CAN bus J1939, one skilled in the art would understand that the CAN bus J1939 is merely one example, and that other types of bus may be used without affecting the scope and spirit of the present disclosure. In one example, the interlock indicator shown in FIG. 2 is part of the communication line 140. In one example, the high voltage DC line shown in FIG. 2 is part of the electrical cable 130.

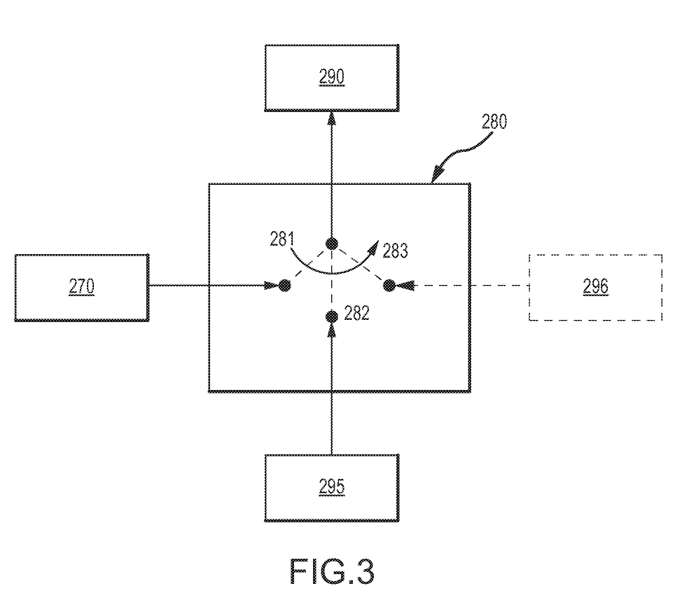

In one example, the shore power switch 280 controls the input voltage path to the electrical load (e.g., refrigeration unit 290). FIG. 3 illustrates an example of voltages paths configured by the shore power switch 280. In one configuration, the shore power switch 280 configures a first path 281 between the inverter 270 and the refrigeration unit 290. One skilled in the art would understand that the refrigeration unit 290 may be any electrical load. In another configuration, the shore power switch 280 configures a second path 282 between the shore power 295 and the refrigeration unit 290. In yet another configuration, the short power switch 280 configures a third path 283. In one example, the third path 283 is an open path where no voltage input is being supplied to the refrigeration unit 290. In another example, the third path 283 is connected to an alternate voltage source 296 (for example, a diesel engine that is part of a trailer system) for supplying an electrical load, such as the refrigeration unit 290. In one example, the diesel engine is part of the same trailer system as the electrical load. In another example, the diesel engine is part of a separate trailer system as the electrical load. Although three voltage paths are shown in FIG. 3 for connecting voltage sources to the refrigeration unit 290, one skilled in the art would understand that other quantities of voltage paths are also within the scope and spirit of the present disclosure.

In one example, the shore power switch 280 is a mechanical switch. In another example, the shore power switch 280 is an electrical switch. For example, the shore power switch 280 may include one or more of the following: MOSFET switch, bipolar switch, electro-mechanical switch, opto-electronic switch, piezo-electric switch, etc.

In one example, the first path 281 includes a first sensor 281a (not shown). In one example, the second path 282 includes a second sensor 282a (not shown). In one example, the third path 283 includes a third sensor 283a (not shown). In one aspect, the first, second and/or third sensors monitor the voltage level through their respective voltage paths. In one example, the voltage level monitored by the first, second and/or third sensors is communicated to a processing unit. Based on the voltage level information on the respective first, second and/or third voltage paths, the processing unit determines the position of the switching within the shore power switch 280 to connect or disconnect the first, second and/or third voltage paths. In one example, the processing unit is part of the second CPU and sensor system 260. In another example, the processing unit is part of the first CPU and sensor system 240. Although the example is presented with voltage paths and the sensors monitoring voltages in their respective voltage paths, one skilled in the art would understand that current and/or power may be monitored without affecting the scope and spirit of the present disclosure.

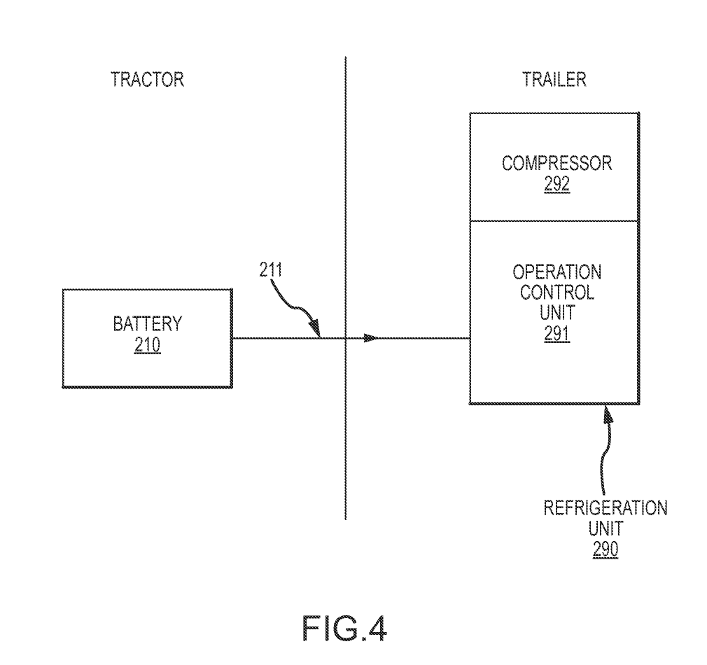

FIG. 4 illustrates an example of a battery-operation control unit interface. In one example, the, refrigeration unit 290 includes an operation control unit (OUT) 291 and a compressor 292. In one example, the OCU 291 includes a processing function. In one example, the battery 210 is coupled to the OCU 291 via a coupling line 211. That is, the coupling line 211 is a voltage, path between the battery 210 and OCU 291.

In one aspect, an inductive load may have a large inrush current, i.e., high current transient level at the start of operation. The goal of a soft start is to minimize the inrush current such that the inverter 270 can supply the inductive load in a reliable manner. In the example where the electrical load is the refrigeration unit 290, the compressor 292 of the refrigeration unit 290 is the inductive load.

The compressor 292 is typically a large inductive load, and having a soft start of the compressor 292 is desirable. One example of soft starting the compressor 292 is to utilize the residual magnetism left in the rotor of the generator 220. However, this technique may be unreliable and uncontrollable because it may be difficult to determine or know whether there is residual magnetism or not. Thus, a more reliable and more controllable alternative is to use the battery 210 for the soft start.

In the example where the voltage source for the compressor 292 is from the generator 220 of the tractor 110, the battery 210 keeps a small voltage continuously to the OCU 291 to keep the OCU 291 in a ready operational state to enable a soft start and a regular operation of the compressor 292. When the voltage source is through the inverter 270, a soft start is desirable. In one example, a soft start may be between 0 to 5 second duration.

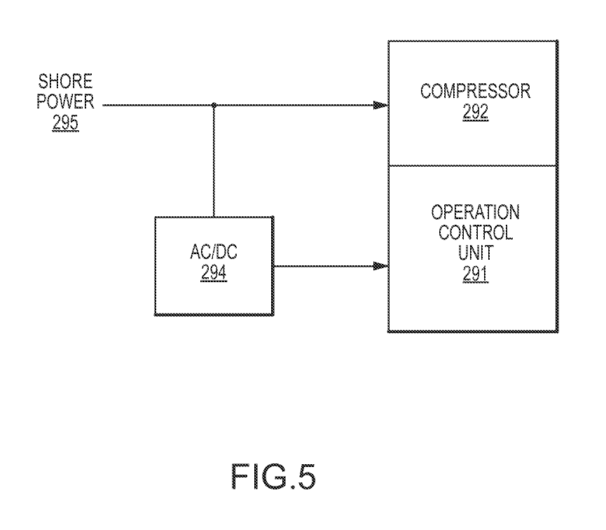

FIG. 5 illustrates an example of a shore power-operation control unit interface. In the example of FIG. 5, the voltage source for the compressor 292 is the shore power 295. In this example, an AC/DC converter 294 may be included to tap off voltage (e.g., 12V to 24V) from the shore power 295 to supply the operation control unit 291. In the example where the voltage source for the compressor 292 is the shore power 295, a soft start is not needed.

In one example sensor information from the first, second and third sensors 281a 282a, 283a (not shown) but disclosed in FIG. 3 are used to help with determining the need of a soft start. In this example, the first, second and third sensors 281a, 282a, 283a from the shore power switch 280 may provide information on the voltage source to the refrigeration unit 290 based on their respective measured voltage levels at the respective first path 281, second path 282 and third path 283. And, in the case where the sensor information indicates that the voltage source is from the tractor 110 (e.g., from the generator 220) and through the inverter 270, a soft start initiation is determined is needed.

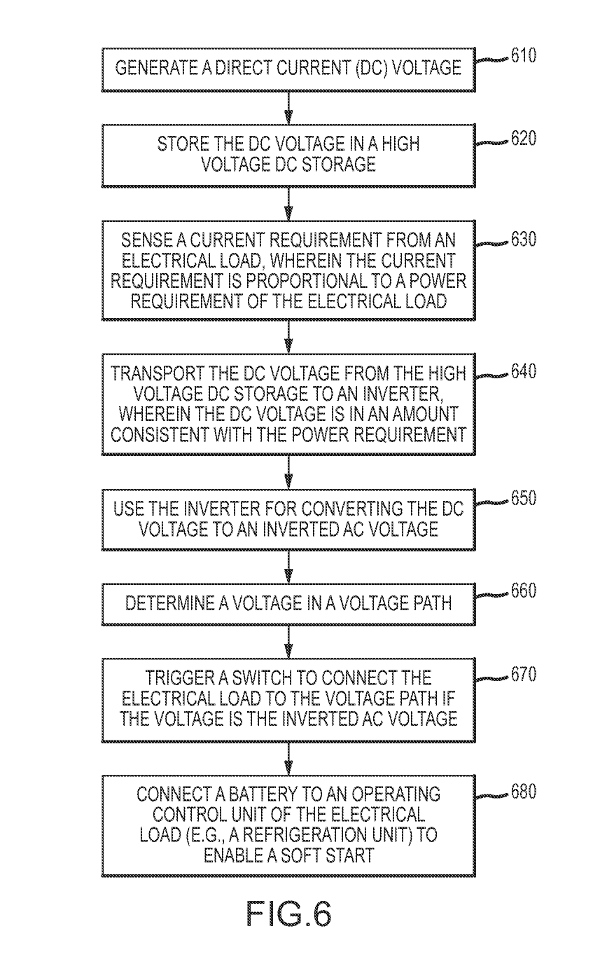

FIG. 6 illustrates,an example flow diagram for transport refrigeration. In block 610 generate a direct current (DC) voltage. In one example, an unregulated AC voltage is generated instead. If the unregulated AC voltage is generated, rectify the unregulated AC voltage to provide a DC voltage (a.k.a. rectified DC voltage). In block 620, store the DC voltage in a high voltage DC storage. In block 630, sense a current requirement from an electrical load, wherein the current requirement is proportional to a power requirement of the electrical load. In one example, a current sensor is used to sense the current. In one example, the electrical load is a refrigeration unit. In block 640, transport the DC voltage from the high voltage DC storage to an inverter, wherein the DC voltage is in an amount consistent with the power requirement. In block 650, use the inverter for converting the DC voltage to an inverted AC voltage. In block 660, determine a voltage in a voltage path. In block 670, trigger a switch to connect the electrical load to the voltage path if the voltage is the inverted AC voltage. In block 680, connect a battery to an operating control unit of the electrical load (e.g., a refrigeration unit) to enable a soft start.

One skilled in the art would understand that the steps disclosed in the example flow diagram in FIG. 6 can be interchanged in their order without departing from the scope and spirit of present disclosure. Also, one skilled in the art would understand that the steps illustrated in the flow diagram are not exclusive and other steps may be included or one or more of the steps in the example flow diagram ma be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units (i.e., processors or CPUs) may be implemented within one or more application specific integrated circuits (ASICs), digital signal processors (DSPs), digital signal processing devices (DSPDs), programmable logic devices (PLDs), field programmable gate arrays (FPGAs), processors, controllers micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer readable medium known in the art or implemented in any computer program product known in the art. In one aspect, the computer-readable medium includes ion-transitory computer-readable medium.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

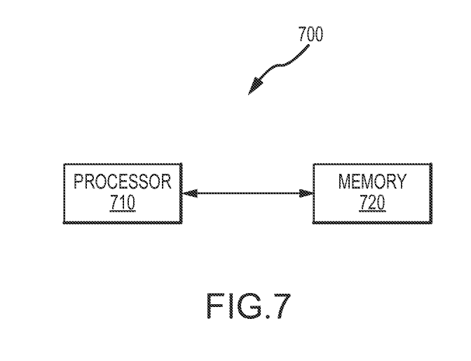

In one example, the illustrative components, flow diagrams, logical blocks, modules and/or algorithm steps described herein are implemented or performed with on or more processors. In one aspect, a processor is coupled with a memory which stores data, metadata, program instructions, etc. to be executed by the processor for implementing or performing the various flow diagrams, logical blocks and/or modules described herein. FIG. 7 illustrates an example of a device 700 including a processor 710 in communication with a memory 720 for executing transport refrigeration. In one example, the device 700 is used to implement the algorithm illustrated in FIG. 6. In one aspect, the memory 720 is located within the processor 710. In another aspect, the memory 720 is external to the processor 710. In one aspect, the processor includes circuitry for implementing or performing the various flow diagrams, logical blocks and/or modules described herein.

The previous description of the disclosed aspects is provided to enable any person killed in the art to make or use the present disclosure. Various modifications to these aspects will be readily apparent to those in the art, and the generic principles defined herein may be applied to other aspects without departing from the spirit or scope of the disclosure.

1. A method for electrical transport refrigeration, comprising:
generating a direct current (DC) voltage;
storing the DC voltage in a high voltage DC storage;
sensing a current requirement from an electrical load, wherein the current requirement is proportional to a power requirement of the electrical load;
transporting the DC voltage from the high voltage DC storage to an inverter, wherein the DC voltage is in an amount consistent with the power requirement;
converting the DC voltage to an inverted AC voltage;
determining a voltage in a voltage path; and
triggering a switch to connect the electrical load to the voltage path if the voltage is the inverted AC voltage.

2. The method of claim 1, wherein the electrical load is a refrigeration unit including a compressor.

3. The method of claim 2, further comprising connecting a battery to an operating control unit of the refrigeration unit to enable a soft start of the compressor.

4. A method for electrical transport refrigeration, comprising:
generating a direct current (DC) voltage or an unregulated alternating current (AC) voltage;
rectifying the unregulated AC voltage to provide a rectified DC voltage, or treating the DC voltage as the rectified DC voltage;
storing the rectified DC voltage in a high voltage DC storage;
sensing a current requirement from an electrical load, wherein the current requirement is proportional to a power requirement of the electrical load;
transporting the DC voltage from the high voltage DC storage to an inverter, wherein the DC voltage is in an amount consistent with the power requirement;
converting the rectified DC voltage to an inverted AC voltage;
determining a voltage in a voltage path; and
triggering a switch to connect the electrical load to the voltage path if the voltage is the inverted AC voltage.

5. The method of claim 4, wherein the electrical load is a refrigeration unit including a compressor.

6. The method of claim 5, further comprising connecting a battery to operating control unit of the refrigeration unit to enable a soft start of the compressor.

7. A tractor-trailer system for electrical transport refrigeration, comprising:
a generator for generating a direct current (DC) voltage;
a high voltage DC storage for storing the DC voltage:
a current sensor for sensing a current requirement from an electrical load, wherein the current requirement is proportional to a power requirement of the electrical load;
an electrical cable for transporting the DC voltage from the high voltage DC storage to an inverter, wherein the DC voltage is in an amount consistent with the power requirement, and wherein the inverter converts the DC voltage to an inverted AC voltage;
a voltage sensor for determining a voltage in a voltage path; and
a switch for connecting the electrical load to the voltage path if the voltage is the inverted AC voltage.

8. The tractor-trailer system of claim 7, wherein the electrical load is a refrigeration unit including a compressor.

9. The tractor-trailer system of claim 8, further comprising a battery for supplying a battery voltage to an operating control unit of the refrigeration unit to enable a soft start of the compressor.

10. A tractor-trailer system for electrical transport refrigeration, comprising:
a generator source for generating a direct current (DC) voltage or an unregulated alternating current (AC) voltage;
a rectifier for rectifying the unregulated AC voltage to provide a rectified DC voltage, or an electrical wire for treating the DC voltage as the rectified DC voltage;
a high voltage DC storage for storing the rectified DC voltage;
a current sensor for sensing a current requirement from an electrical load, wherein the current requirement is proportional to a power requirement of the electrical load;
an electrical cable for transporting the DC voltage from the high voltage DC storage to an inverter, wherein the DC voltage is in an amount consistent with the power requirement, and wherein the inverter converts the DC voltage to an inverted AC voltage;
a voltage sensor for determining a voltage in a voltage path; and
a switch for connecting the electrical load to the voltage path if the voltage is the inverted AC voltage.

11. The tractor-trailer system of claim 10, wherein the electrical load is a refrigeration unit of the compressor.

12. The tractor-trailer system of claim 11, further comprising a battery for supplying a battery voltage to an operating control unit of the refrigeration unit to enable a soft start of the compressor.
